(19) United States
(12) Patent Application Publication
(10) Pub. No.: US 2025/0329110 A1
(43) Pub. Date: Oct. 23, 2025

(54) SYSTEM FOR REAL TIME SIMULTANEOUS USER LOCALIZATION AND STRUCTURE MAPPING

(71) Applicant: Al Tech Holdings, Inc., Chicago, IL (US)

(72) Inventors: Alexander Gorsuch, Chicago, IL (US); Paul Couston, Chicago, IL (US); Thomas Kaufmann, Chicago, IL (US)

(21) Appl. No.: 18/856,621

(22) PCT Filed: Apr. 20, 2023
(86) PCT No.: PCT/US2023/019271

§ 371 Date: Oct. 13, 2024

Related U.S. Application Data
(60) Provisional application No. 63/333,805, filed on Apr. 22, 2022.
(60) Provisional application No. 63/433,449, filed on Dec. 17, 2022.

(51) Int. Cl. G06T 17/05; G06T 7/579; G06T 7/593; G06T 7/70

(52) U.S. Cl. CPC G06T 17/05; G06T 7/579; G06T 7/593; G06T 7/70; G06T 2200/16; G06T 2207/10021; G06T 2207/10028; G06T 2210/56

(57) ABSTRACT

A system is configured to (1) determine location of a user and/or objects within a structure and/or (2) create a map of contours of the structure, as the user navigates a space within a structure, the system comprising: a) an apparatus to function in hazardous environments, wherein the apparatus includes first and second sensors configured to generate first and second image streams; and b) one or more servers configured to communicate with the apparatus via a network, and execute a method comprising: receiving the first and second image streams from the first and second sensors; comparing the first and second image streams to determine differences in location of points on the first and second image streams, each difference representative of a location of an obstacle and/or the user with respect to each obstacle; and creating a point cloud of the location of the obstacles and/or the user within the structure.

### CROSS REFERENCE TO RELATED APPLICATIONS

The application claims priority to U.S. provisional application No. 63/333,805, filed Apr. 22, 2022, entitled “Location Tracking System of Users in Hazardous Environments” and U.S. provisional application No. 63/433,449, filed Dec. 17, 2022, entitled “System For Simultaneous Localization and Mapping” both of which are incorporated by reference herein.

### FIELD OF THE INVENTION

The present invention relates to a system for real time simultaneously determining user location and creating a map of the structure as the user moves throughout the structure.

### BACKGROUND OF THE INVENTION

Firefighters are typically first responders on premises to control and extinguish fires that threaten life and property as well as rescue persons from confinement or dangerous situations. Personal protective equipment (PPE), such as masks, helmets, gloves, air tanks, hoses, boots and body armor are worn by these firefighters (or other users in austere environments with challenging conditions). Even with such available PPE, firefighters are at great risk for injury and/or of suffering a catastrophic event. Today, certain technologies that are intended to be used in austere environments like fire incidents typically incorporate step or gate tracking to determine firefighter location on premises. However, these technologies offer little accuracy as such technologies are unable to precisely track firefighter movements and identify various types of firefighter movements. Further, such technologies don't provide any mapping capability of the internal layout of a structure. Thus, it would be advantageous to provide improvements to these technologies.

### SUMMARY OF THE INVENTION

A system for simultaneously determining in real time location of a user and creating a map of the structure as the user moves throughout a structure.

In accordance with an embodiment of the present disclosure, a system is configured to a system configured to (1) determine location of a user and/or objects within a structure and/or (2) create a map of contours of the structure, as the user navigates a space within the structure the system comprising: a) an apparatus configured to be mounted on a user and to function in hazardous environments, wherein the apparatus includes first and second sensors configured to generate first and second image streams, respectively, of the structure and/or objects within the structure as the user navigates the space within the structure; and b) one or more servers configured to communicate with the apparatus via a network, the one or more servers configured to execute a method, the method comprising: receiving the first and second image streams from the first and second sensors, respectively, of the first and second sensors; comparing the first and second image streams to determine differences in location of points on the first and second image streams, each difference representative of a location of an obstacle and/or the user with respect to each obstacle; and creating a point cloud of the location of the obstacles and/or the user within the structure.

In accordance with yet another embodiment of the disclosure, a system configured to (1) determine a location of a user and/or location of objects within the structure and/or (2) create a map of contours of the structure, as the user moves throughout a structure, the system comprising: a) an apparatus that is configured to be mounted on a user, the apparatus is configured to provide data monitoring and/or communication of the user to facilitate user deployment and deliver navigation guidance in the hazardous environments, the apparatus includes (1) first and second sensors configured to generate first and second image streams, respectively, of the structure and/or objects on within the structure as the user moves within the structure and (2) one or more user tracking devices (UTDs) for tracking the user as the user moves throughout the structure and configured to receive the first and second images streams; and b) one or more servers configured to communicate with the one or more user tracking devices via a network, the one or more servers configured to execute a method, the method comprising: receiving the first and second image streams over the network from the one or more UTDs generated by the first and second sensors, respectively; comparing the first and second image streams to determine differences in location of points on the first and second image streams, each difference representative of a location of an obstacle and/or the user with respect to the obstacle; and creating a point cloud of the location of the obstacles and/or the user within the structure.

In accordance with yet another embodiment of the disclosure, a system for real time determining location of users and/or mapping of a structure, as the users move throughout a structure, the system comprising: (a) a set of nodes that function together as a first network of nodes in which the set of nodes communicate directly with one another and route data between nodes of the set of nodes, wherein each node of the set of nodes comprises a user tracking device (UTD) mounted on a user for tracking the user as the user moves throughout the structure, wherein the UTDs are configured to enable the set of nodes to function as the first network of nodes; (b) a set of first and second sensors for a set of users, respectively, each set of first and second sensors mounted on each user and in communication with each UTD mounted on the user, each set of first and second sensors mounted on a each user configured to (1) generate first and second image streams respectively of the structure and/or objects within the structure as the user moves throughout the structure and (2) transmit the first and second image streams to the UTD mounted on the user; (c) one or more servers configured to communicate with the set of nodes over a second network, the one or more servers configured to execute a method, the method comprising: receiving first and second image streams over a second network from each UTD generated by each set of first and second sensors, respectively.

In yet another embodiment of the disclosure, a system configured to real time simultaneously (1) determine a location of a user and/or location of objects within a structure and/or (2) create a map of contours of the structure, as the user moves throughout a structure, the system comprising: a) an apparatus that is configured to be mounted on a user, the apparatus is configured to provide data monitoring and/or communication of the user to facilitate user deployment and deliver navigation guidance in the hazardous environments, the apparatus includes (1) first and second sensors configured to generate first and second image streams, respectively, of the structure and/or objects on within the structure as the user moves within the structure and (2) one or more user tracking devices (UTDs) for tracking the user as the user moves throughout the structure and configured to receive the first and second images streams; and b) one or more servers configured to communicate with the one or more user tracking devices via a network, the one or more servers configured to execute a method, the method comprising: receiving the first and second image streams over the network from the one or more UTDs generated by the first and second sensors, respectively; comparing the first and second image streams to determine differences in location of points on the first and second image streams, each difference representative of a location of an obstacle and/or the user with respect to the obstacle; creating a point cloud of the location of the obstacles and/or the user within the structure; and creating a map of a floor plan of the obstacles based on the point cloud created.

### BRIEF DESCRIPTION OF DRAWINGS

FIG. 1 depicts a diagram of an environment in which an example system for real time simultaneously determines the location of a user and creates a map of the structure as the user moves throughout a structure.

FIG. 2 depicts a block diagram of the example system in FIG. 1.

FIG. 3 depicts a diagram of an architecture of nodes of the system in FIG. 1 for determining real time user location and creating a map of the structure.

FIG. 4A-4D depicts a flow diagram of the process steps of the example system in FIG. 1.

FIG. 5 depicts a flow diagram of the steps for performing the function of another example tracking system.

FIG. 6 depicts a block diagram of an example server of the central computer system shown in FIGS. 1 and 2.

### DETAILED DESCRIPTION OF THE INVENTION

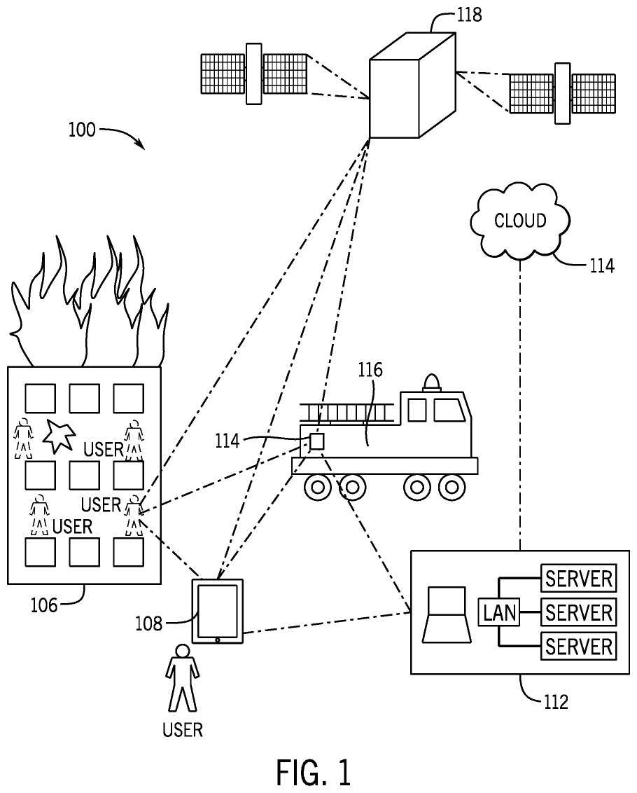

FIG. 1 depicts a diagram of an environment in which an example system 100 for real time simultaneously determines the location of a user (localization) and creates a map of the structure as the user moves throughout a structure. In brief, the system is configured to determine the location of a firefighter within a structure (a premises) and internal layout of the structure to assist in continued firefighter deployment and navigational guidance.

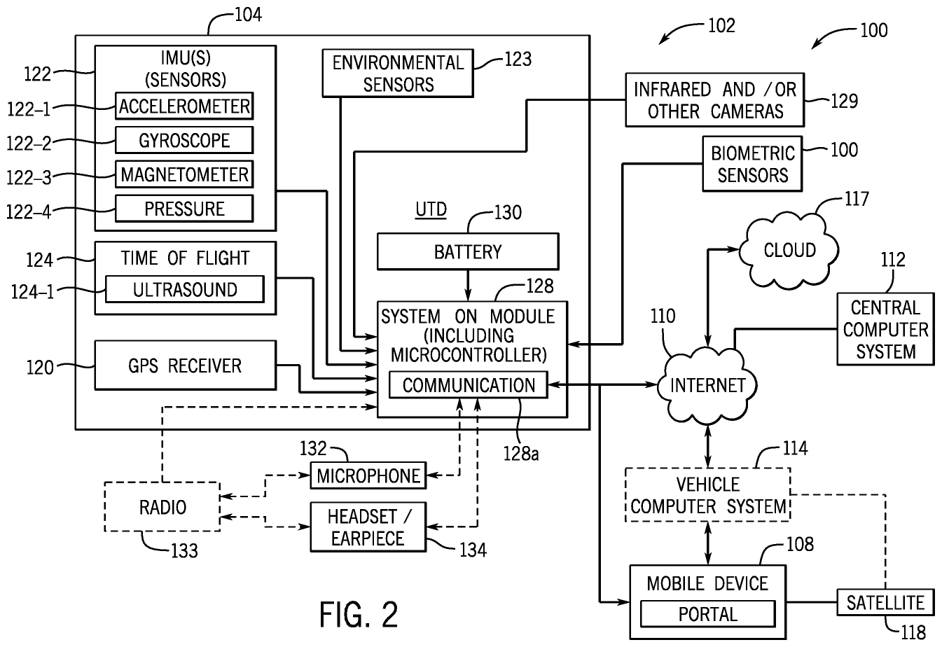

Specifically, system 100 is configured to simultaneously (1) determine the location of a user(s) (e.g., firefighters) as the user moves throughout a structure and (2) create a map of the contours of such a structure itself. FIG. 2 depicts a diagram of system 100 in FIG. 1.

In short, system 100 incorporates stereophotogrammetry, depth estimation, step tracking and pressure readings to create a map of the structure and to determine user location within the structure in any environment. Stereophotogrammetry is a technique that constructs point clouds from depth estimations. In operation, once the user/operator enters a structure, an array of sensors such as cameras on the user/operator are used to track inside the structure. For example, two or more cameras that are mounted on the front of the helmet of the operator/user generate these image streams and is stereophotogrammetry used to build a point cloud. As the operator/user navigates the space inside the structure and views the structure and objects within that structure, the data is received relating to the geometry, colors, and compelling visual stimuli. As the point cloud changes based on a firefighter's (operator/user) movement, for example, as the firefighter moves left, observed objects in the point cloud will move to the right. As the firefighter moves up, observed objects will move down in the point cloud. As a firefighter moves through a building/structure, his/her X and Y coordinates change, reflecting his/her horizontal position. Since firefighters are typically moving along a floor, the observed point cloud doesn't change as much in the Z-axis coordinates, or vertical position, and the Z-axis will remain relatively constant. This is reflected in the firefighters' location changing in the X or Y axis but not the Z axis. However, when the firefighters move up or down stairs or ladders, the Z-axis of the observed points will change, reflecting their positioning in the Z-axis coordinates changing accordingly. Therefore, while the point cloud's X and Y coordinates change as firefighters move horizontally, the Z-axis coordinates change more significantly when they move vertically. By comparing the observed changes in point clouds, captured by the light detection and ranging (LiDAR) and visual sensors, with the data from the inertial measurement unit (IMU), a more accurate and precise estimation of the firefighter's position can be obtained. This includes the Z-axis, which is important for determining which floor the firefighter is on. The barometric pressure sensor provides additional data that can help identify changes in altitude, further refining the Z-axis positioning. This is especially useful in scenarios where LiDAR or IMU data alone may not be sufficient. To create a useful representation of the environment, the point clouds gathered from the various sensors are processed and combined to form a series of occupancy grids. These grids are then associated with specific floor levels, enabling the system to determine which floor the firefighter is on. By “binning” the operators, or assigning them to specific floors identified during the satellite imagery and street view steps identified earlier, the system can more effectively track and manage the movement of firefighters within the building. Details are described herein below.

System 100 is configured to function in such hazardous environments including severe and challenging austere environments. Examples of such austere environments include fires in residential, industrial, commercial, or other installations and accompanying fumes, toxic gas release and exposure and/or other harmful conditions. Additional examples of other environments include non-fire related environments such as military and law enforcement conducted operations, hazardous materials and confined space entry.

System 100 includes apparatus 102 that is configured to be mounted on a user without compromising the user's equipment or changing the way in which the user accomplishes the task at hand. The mounting may be on the user's skin, clothing etc. or on items of a user's personal protective equipment (PPE) including a user's helmet (as an example). PPE as known to those skilled in the art is worn by the user to minimize exposure to hazards that cause injuries and illnesses. These injuries and illnesses may result from contact with chemical, radiological, physical, electric, mechanical or other workplace hazards. PPE may include items such as gloves, safety glasses, shoes, earplugs or muffs, hard hats or helmets, respirator, coveralls, vests and full body suits.

Apparatus 102 includes one or more hands free modules and other components that provide user data monitoring and/or communication for remote review, analyses and user guidance in hazardous environments. The user data monitoring and/or communication includes, for example, voice communication, biometric monitoring, environmental monitoring, image visualization, user location tracking and/or other functions of a user as described below in detail. The data collected will also be used to improve remote incident command capability. This will help incident command to (1) gain insight into a user's health status, PPE status as well an internal building structure and to (2) guide user (firefighter) deployment and navigation as described hereinbelow.

The modules are configured to be mounted on user PPE or directly on the user (wearer). (Modules as described herein may also be referred to as sensor modules.)

Apparatus 102 includes user tracking devices (UTD) 104 for tracking users (e.g., firefighters) entering premises 106 (i.e., a structure or property) under the hazardous environments described above. A premises or structure or property may be a house, building, barns, apartments, offices, stores, schools, industrial buildings, or any other dwelling or part thereof known to those skilled in the art. In this embodiment, apparatus 102 also includes other functionality such as voice communication and biometric monitoring as part of UTD 104, but in other embodiments these functions may be components or modules that are separate from the UTD 104 or not present at all. In the embodiment described herein, system 100 includes two or more user tracking devices (UTDs) as described in more detail below. However, any number of UTDs may be employed as known to those skilled in the art. Examples of the particular type, construction and mechanisms for mounting apparatus 102 and/or UTD 104 are described in more detail below.

System 100 incorporates mobile device 108 that communicates with a network and central computer system 112 (described below) via the Internet 110. Mobile device 108 is configured to access a portal of data obtained from the biometric sensors as described in more detail below. Mobile device 108 include tablets (e.g., iPad), phones and/or laptops as known to those skilled in the art. The platform, as described in detail below, can be viewed on any type of mobile device 108 such as a phone, laptop, or desktop with proper credentials via a web application. However, any number of mobile devices may be used. Mobile device 108 communicates with cloud 117 to access various data as known to those skilled in the art. Mobile device 108 will function as a command unit as described in more detail below.

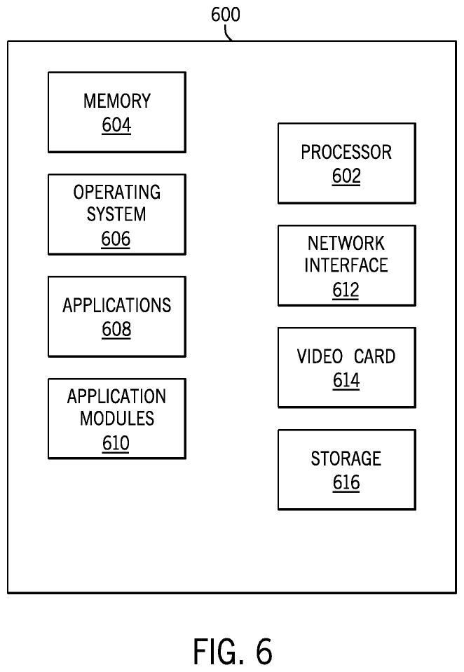

System 100 further incorporates central computer system 112 that communicates with a network such as Internet 110 and the central computer system 112 via the Internet 110. Mobile device 108 will access data and the platform for performing the function of the location tracking system described herein on central computer system 112 via Internet 110. In an embodiment, complex computations are processed via the cloud. In another embodiment, these computations are processed locally on the hardware. In a final embodiment, computations are made in both the cloud and on the local hardware. (Alternatively, mobile device 108 may store and process the platform for performing the functions of the location tracking system described herein and may directly communicate with UTD 104.) Central computer system 112 includes one or more servers and other devices that communicate over a local area network (LAN). Servers each include conventional components including one or more processors, memory, storage such as a hard drive(s) or SSD, video cards with processors, network interfaces and additional components known to those skilled in the art. Central computer system 112 also communicates with cloud 117 to access various data as known to those skilled in the art. An example server is depicted in FIG. 6 along with certain components.

In one embodiment, system 100 may also incorporate computer system 114 on vehicle 116 (e.g., fire truck) that communicates with mobile device 108 via WIFI, Long Range Radio (LoRa), Bluetooth Low Energy (BLE), Cellular (4G/LTE), Ultra-Wide Band (UWB) or other communication protocol and communicates with central computer system 112 via Internet 110 as known to those skilled in the art. A vehicle may be a fire truck, fire engine, or any equivalent first responder vehicle or other vehicles known to those skilled in the art for rendering service on premises in hazardous environments.

Mobile device 108 as well as vehicle computer system 114 are configured to receive geolocation data from satellite 118 as known to those skilled in the art.

As described above, apparatus 102 includes UTD(s) 104 for users (e.g., firefighters) entering premises 106 under hazardous environments described above. In one embodiment, two user tracking devices will be mounted on each user, one preferably mounted on a user's head (e.g., on PPE or directly) and the other preferably mounted on an ankle, leg, boot, wrist, or in a pocket of the user. The head-mounted device or module provides orientation while the ankle or leg-mounted device or module provides steps. Additional steps could be obtained from a wrist mounted device. UTDs 104 are also adapted to access geolocation data via satellite 118 via global navigation satellite (GNSS) transceiver 120 as known to those skilled in the art. Both UTDs 104 (apparatuses 102) are configured to communicate with mobile device 108 and central computer system 112 via Internet 110 as known to those skilled in the art. Communication between apparatus 102 and mobile device 108 may be conducted directly between the two components or via central computer system 112 (or vehicle computer system 114) as known to those skilled in the art. This is described in more detail below. In addition, mobile device 108 may alternatively communicate directly with UTD 104 without need for central system 112 and/or vehicle computer system 114.

UTD 104 includes inertial measurement unit (IMU) 122 for measuring and reporting a user's movement, i.e., specific force, angular rate, and orientation of the user's body as known to those skilled in the art (i.e., acceleration, velocity and position) using accelerometer 122-1, gyroscope 122-2 and magnetometer 122-3. Pressure sensor 122-4 is also incorporated and used to help inform vertical distance (Z axis), in addition to the process described herein. In particular, IMU 122 functions to detect user linear acceleration using accelerometer 122-1 and rotational rate using gyroscope 122-2. Magnetometer 122-3 is used as a heading reference. IMU 122 may also be supplemented by GNSS data. All three components (accelerometer, gyroscope and magnetometer) are employed per axis for each of the three principal axes: pitch, roll, and yaw. In the present embodiment, IMU 122 mounted on the user's head is used to determine user orientation or direction and the IMU 122 on the user's foot is used to determine the distance in steps along the X, Y and Z axes. In this embodiment, UTD 104 further includes environmental sensors 123 including barometric pressure that helps calculate the relative altitude of the user. In some embodiments, there are additional toxicity sensors for compounds like carbon monoxide, hydrogen cyanide, nitrogen dioxide, sulfur dioxide, hydrogen chloride, aldehydes, and such organic compounds as benzene.

In addition, data collected from various movements and gaits tied to individual operators/users can train a machine learning (ML) model to better recognize user gait, crawl, level step, and stair transition step movement patterns in a variety of circumstances. In other embodiments, one or more environmental sensors 123 may be separate from UTD 104. The process using ML is described in more detail below.

UTD 104 further includes one or more Time of Flight (ToF) sensors 124 such as ultrasound sensor 124-1 (as an example) that is used to detect and determine distance between UTD 104 (user) and objects within premises 106 such as walls and doors, which would establish internal configuration. UTD 104 further includes System on Module (SoM) 128 and battery 130. This sensor can also be used to verify predicted floor plans in real-time by taking into account user position and distance to boundaries such as walls, doors, windows.

Microphone 132 and headset/earpiece 134 (and radio 133 as described below) are part of apparatus 102. These components are preferably neither part of UTD 104 itself nor its functionality (as shown in FIG. 2). However, these components may be designed to be part of UTD 104 if desired.

System on Module (SoM) 128 includes a microcontroller unit (MCU) or other processing unit that controls the operation of UTD 104 (and apparatus 102) as known to those skilled in the art. SoM 128 receives and processes sensor and other data from sensors IMU 122, sensors 124, biometric sensors 126, environmental sensors 123, ultrasound sensors 124-1, infrared and other cameras 129 (as described in more detail below), as well as any other sensors.

SoM 128 integrates communication module 128a to enable data to be sent to mobile device 108. Communication module 128a may transmit data from SoM 128 to mobile device 108 via a LoRa module (board) or any other wireless protocol or techniques such as WIFI, Bluetooth, radio and/or LTE modules (to name a few). In the event communication from any UTD to mobile device 108 or satellite 118 is hindered or blocked due to structural building interference (such as basements, stairwells, or other objects or structural impediments), data transmission may be achieved between multiple users via a meshing network on the UTDs. In this way, the users may transmit data between and through each other (piggybacking) to maintain communication with mobile device 108 and/or central computer system 112. SoM 128 may communicate with third party systems via Bluetooth, or any other protocol as known to those skilled in the art.

Battery 130 provides power to SoM 128 as known to those skilled in the art, SoM 128 and sensors. In one embodiment, battery 130 also powers the throat microphone 132 and earpiece 134 and other components as needed that are part of apparatus 102. However, in another embodiment, sensors 122 and 124 as well as SoM 128 may be powered independently of microphone 132 and earpiece 134 from other power sources directly integrated into existing batteries on the user's self-contained breathing apparatus (SCBA) as described in more detail below, radio, other PPE, or 3rd party source. Also, apparatus 102 may employ a port for direct charging and/or data transfer or software updates. Alternatively, apparatus 102 may be charged inductively (without port) for weatherproofing and moisture prevention. In another embodiment, charging can be delivered via induction-based coils without the need for a port to further improve ruggedization, weatherproofing, and moisture prevention In this respect, apparatus 102 may be configured to receive software updates over the air. Battery 130 is preferably rechargeable, but it may be the type that can be replaced.

Microphone 132 is configured to receive voice commands and headset/earpiece 134 is configured as an audible device as known to those skilled in the art. In one example, microphone 132 and earpiece 134 are configured to communicate with mobile device 108 via (interface with) directly through SoM 128. Alternatively, microphone 132 and headset/earpiece 134 may communicate with mobile device 108 or through a traditional radio 133 employed by users in hazardous environments such as fires. Additionally, the voice data from the radio 133 or headset/earpiece 134 can be processed as text on the portal on the mobile device 108 and may be done directly through SoM 128.

As described above, apparatus 102 may also include one or more biometric sensors 126 to measure and obtain or collect critical health information of the user. In the example in FIG. 2, biometric sensors 126 are configured as separate component(s) of UTD 104 as these sensors contact the wearer (user) directly such as the wearer's skin. However, sensor 126 may alternatively be part of UTD 104 itself. Biometric sensors are described in more detail below, but example biometric sensors include temperature (body) sensor for measuring body temperature, skin temperature sensor for measuring the temperature under the PPE of the user and a combination pulse sensor and oxygen saturation sensor for measuring heart rate and oxygen saturation of the user. In some embodiments, galvanic skin response, blood pressure, EKG sensors may also be placed. A heart rate sensor may also be employed. Any type and number of sensors may be employed to achieve desired results for various environments. Data from the biometric sensors are transmitted via JSON architecture to a portal on mobile device 108, but any other architecture may be used as known to those skilled in the art.

Apparatus 102 further includes one or more cameras 129 (e.g., infrared (IR)) as sensors that are connected to the SoM 128. IR cameras 129 are used to create images and capture other data and transmit to mobile device 108 or computer via SoM 128 as described in more detail below. IR cameras 129 (and any other cameras) are shown as separate from UTD 104 in this embodiment in FIG. 2. For example, the cameras may be attached to PPE such as the front of a user's helmet. Two or three cameras are preferably attached to the front of a user's helmet, but any number of cameras or other sensors may be carried by a user at various locations on the user or his/her PPE. Apparatus 102 may include other cameras as known to those skilled in the art. In addition, the cameras may alternatively be part of UTD 104.

In one embodiment, biometric sensors 126 and/or microphone 132 are mounted on a user's neck as it is a point for biometric data (carotid arteries) collection and sound detection. In one example, UTD 104, biometric sensors and/or microphone 132 may be integrated as part of apparatus 102, in one piece or component. Alternatively, sensors may be mounted separately (from themselves and/or microphone). Both the biometric sensors may be mounted on other user body parts provided they offer desired data measurement/collection. Microphone 134 must be in proximity to a user's head to provide adequate sound detection such as on the SCBA or fire hood, e.g., to detect voice commands for clearing rooms, mayday or other commands, etc. (Voice commands may be issued directly on the portal.)

Headset/earpiece 134 is preferably mounted on or in a user's ear, but headset/earpiece 134 may be mounted on the user at other locations in proximity to the user's ear (for hearing detection). An example earpiece is bone conductive or otherwise but this earpiece requires contact with or slightly forward of the user's ear.

The headset/earpiece may be a low power draw earpiece and duplex throat microphone with the ability to press a button associated with the microphone to initiate talking. This button to activate the microphone can be located on the neck piece or on the earpiece for ease of use. In addition, some example embodiments, push to talk or pinch to talk buttons may be utilized. For example, such a button may be located proximate to the neck to allow the user to easily enable communication. In some embodiments, a pinch-to-talk button utilizes one or more mechanical switches. In other embodiments, one or more RFIDs and sensors are embedded in the fingertips and neck. In some example embodiments, integrated adaptive noise cancellation is included in the system 100. This communication system is preferably hands-free, noise-canceling, and allows for seamless communications between the operator and additional team members via radio transmission.

In another embodiment, the biometric sensors 126 are mounted on a user's wrist for ease of use and to avoid discomfort and potential strangulation. In addition, other third-party biometric devices may be used with system 100 such as those mounted on arms, wrist and core (i.e., wrapped around chest or stomach).

Notifications of abnormal thresholds may be triggered and shown. LED alerts may be employed for hardware issues or biometric data and/or threshold analyses abnormalities (e.g., temporary spikes or prolonged time spent above thresholds). Voice analysis and commands may trigger alerts. Vibration, audio alerts or other notifications may be employed. Thresholds and states may be set by an individual user/operator. Voice to text functionality and command to voice (via portal) may be employed.

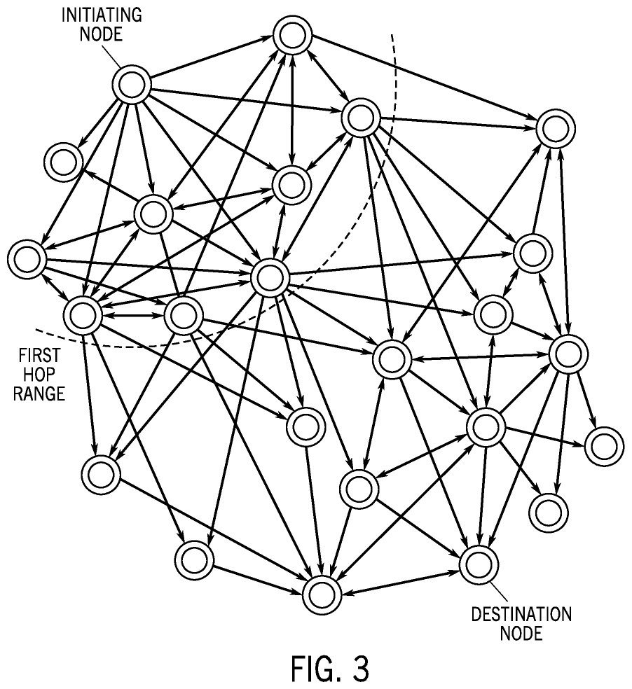

FIG. 3 depicts a diagram of an architecture of nodes for real time user location determination and structure mapping as described herein. Each node represents or comprises a UTD on a user described herein as. The hardware of the UTDs enable this architecture to function as a mesh network in which the nodes connect directly, dynamically and non-hierarchically to as many other nodes as possible and cooperate with one another to efficiently route data to and from a client, source or user/operator (in this case). Data from a user/operator can be carried by another until it reaches outside of a signal-denied environment. This is useful for when signals are constrained by a structure.

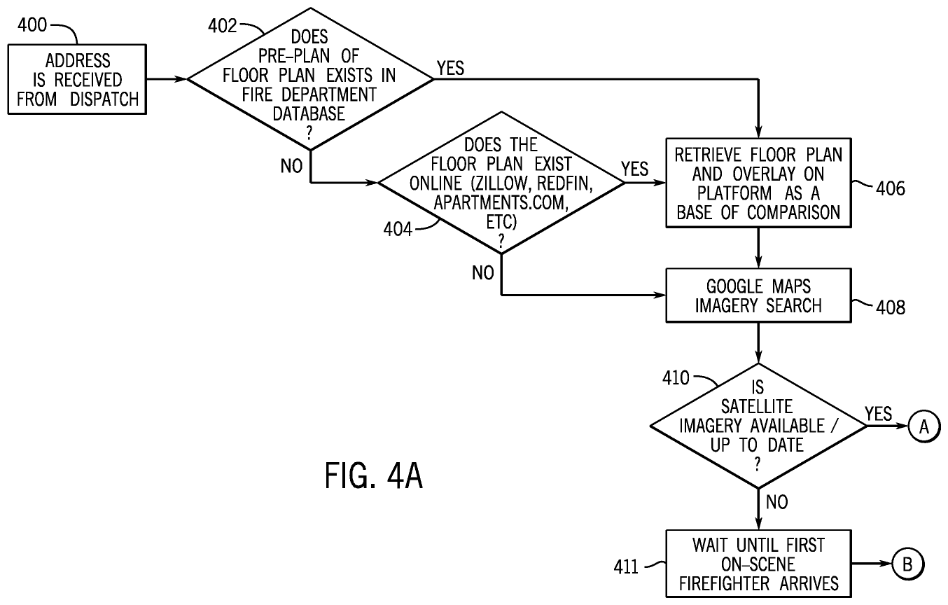

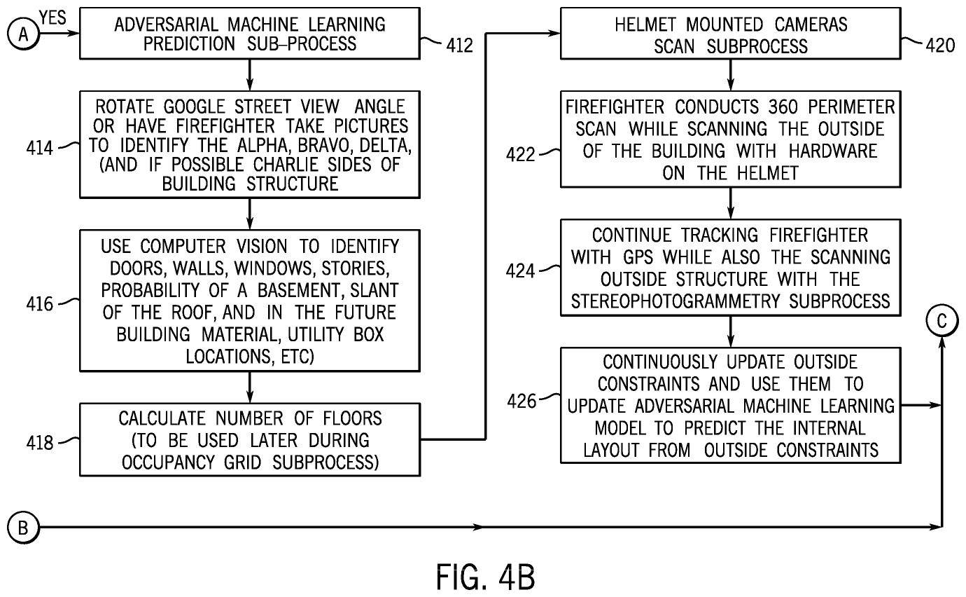

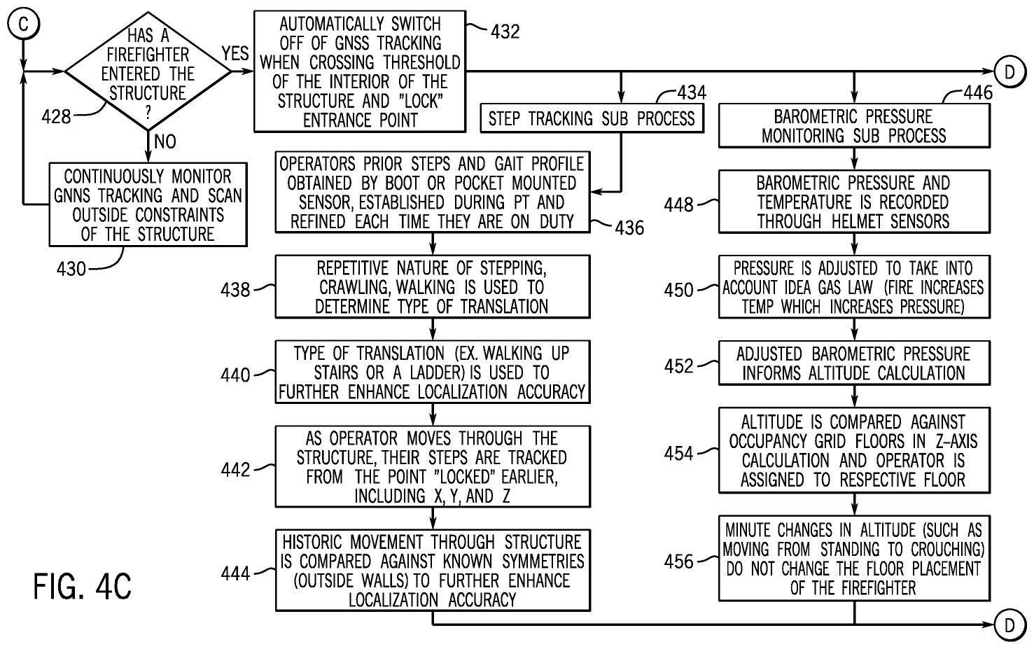

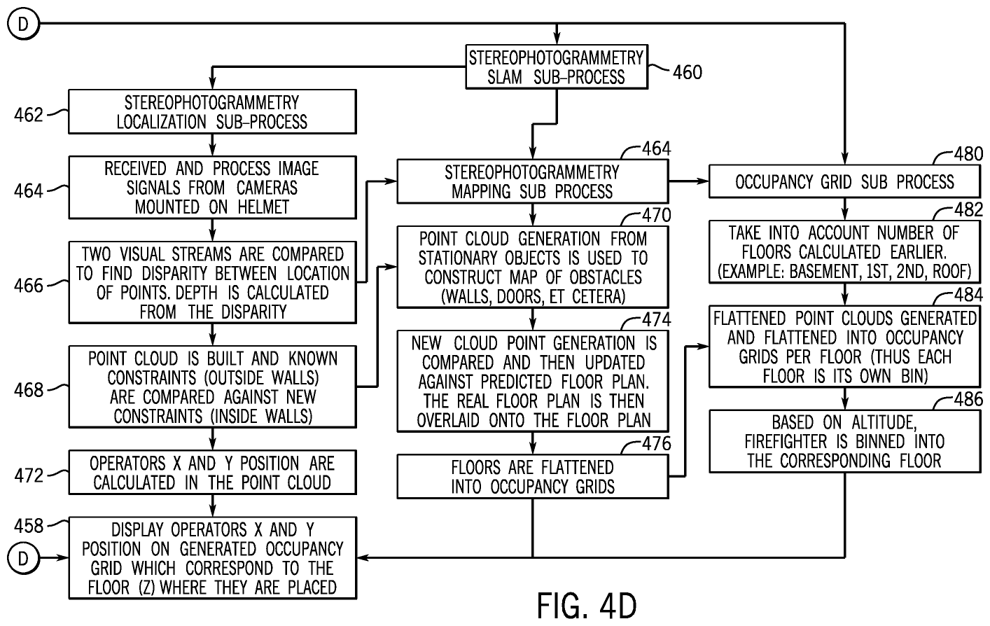

FIGS. 4A-4D depicts a flow diagram of the process steps of example system 100. As described above, system 100 is configured to simultaneously (1) determine the location of a user(s) (e.g., firefighters) as the user moves throughout a structure and (2) create a map of the contours of such a structure itself. The process steps may be implemented by the central computer system 112, vehicle computer system 114, apparatus 102 and/or cloud 117. For this discussion, the process steps may refer to execution by the system 100.

Execution begins at step 400 wherein an address (message) is received from a dispatch. The message is typically an address of a structure experiencing austere conditions. In this instance, it is a fire in a building structure. System 100 incorporates techniques such as depth estimation, stereophotogrammetry, step tracking, pressure for location and mapping. Stereophotogrammetry is 3D coordinate production using two or more images (streams) taken from different fixed points in space, called the baseline to achieve depth/distance. Details are described herein below.

Execution proceeds to decision step 402 wherein system 100 determines if floor plans exist in a fire department database. If not, execution proceeds to decision diamond 404 wherein system 100 determines if floor plans exist online on websites such as Zillow, Redfin, Apartments.com (to name a few examples). If floor plans exist in the fire department database, floor plans will be retrieved at step 406 and overlaid on a platform as a base to compare to the online floor plan uncovered. Execution then proceeds to step 408 and decision step 410 wherein system 100 will search Google and other source map imagery engines to determine if a map imagery is available. If yes, execution proceeds to the machine learning prediction subprocess under box step 412. If not, system 100 will wait until on-scene firefighters arrive 411 and execution proceeds to step 428 as described in detail below.

Under machine language prediction sub-process 412, execution proceeds to step 414 wherein system 100 rotates the Google street view angle to identify the various walls or sides of the building including alpha (front), bravo (rear) and delta and charlie sides of the building structure. Execution proceeds to steps 416 and 418 wherein doors, wall, windows stories, basement assessment roof slant and building materials are identified from computer vision (e.g., street view features from cameras and Google maps) and the number of floors are calculated (for subsequent use during occupancy grid subprocess) using machine learning. This machine learning subsystem acts in the same heuristic manner as incident commanders do, as an example, “large windows next to a front door indicate a living room most of the time” or “a small window higher up often indicates a bathroom” as these are common observances in the dataset that the system described herein has run through as well as the dataset observed by incident commanders during their career of fire response.

Execution proceeds to helmet mounted structure/cameras scan subprocess 420. In this respect, execution proceeds to steps 422 and 424 wherein first on-scene firefighters conduct a 360 perimeter scan of the outside of the building structure with hardware (cameras) on the helmet and these firefighters are continually tracked with GNSS while scanning the outside of the building structure. Execution proceeds to step 426 wherein outside structural constraints are updated and used to update the adversarial machine learning model to predict the internal layout from outside constraints.

Execution proceeds to decision step 428 wherein system 100 determines if the firefighter has entered the building structure. If not, system 100 continuously monitors GNSS tracking and scans outside constraints of the structure until the firefighter enters the structure at step 430. Once the firefighter enters the structure, i.e., crosses the threshold of the interior of the structure and “anchors” entrance point, the GNSS tracking of the operator/user is automatically switched off at step 432. Execution then proceeds to step 434 and 446 to several sub-processes (steps performed in parallel) including (1) step tracking sub-process, (2) barometric pressure Monitoring sub process, (3) stereophotogrammetric (SPG) simultaneous location and Mapping (SLAM) sub-process and (4) occupancy grid sub-process. These sub-processes are described below.

Under the step tracking sub-process 434, execution proceeds to step 436 wherein system 100 receives and processes an operator's (user's) prior steps and gait profile by a boot, jacket, or pocket mounted sensor on the operator including the IMU. Execution proceeds to step 438 wherein system 100 determines the type of translation of the operator based on the repetitive nature of stepping, crawling and walking of the operator. Execution moves to step 440 wherein the type of translation (e.g., walking upstairs or a ladder) is used to further enhance localization accuracy.

Execution then proceeds to steps 442, 444 wherein the operator's steps are tracked as he/she moves throughout the structure from the point “locked” earlier including the user's position along X, Y and Z axes and operator historic movement throughout the structure is compared against known symmetries localization accuracy.

Under the barometric pressure monitoring sub-process 446, execution proceeds to step 448 wherein system 100 records barometric pressure and temperature though the helmet sensors. Execution proceeds to step 450 wherein pressure is adjusted to take into account ideal gas law (as fire increases temperature which increases the pressure). Execution proceeds to step 452 wherein system 100 uses the adjusted barometric pressure to inform altitude calculation. Execution proceeds to step 454 wherein system 100 the altitude calculated is compared against “binned” (floor designation) occupancy grid to a z-axis calculation. As the last step under sub-process 444, execution proceeds to step 456 wherein system 100 ensures that minute changes in altitude, such as moving from standing to crouching, does not change the floor occupancy grid placement of the firefighter by only changing floor placement when there is continuous change that is enough to meet or exceed the calculated difference in floor altitudes. Execution then proceeds to step 458 as described in more detail below.

Under the stereophotogrammetry SLAM sub-process 460, there are two paths in the process as the sub-processes indicates: (1) stereophotogrammetry localization sub-process 462 and (2) stereophotogrammetry mapping sub-process 464. As part of (1) stereophotogrammetry localization 462, execution proceeds to step 464 wherein image or visual signal streams are received and processed from two or more visual and/or ranging sensors mounted on the helmet of the operator/user. These sensors. i.e., cameras or ranging sensors may be LiDAR, Infrared (IR) cut cameras, visual spectrum cameras (to name a few examples). As the operator walks through the inside structure, they look at interesting geometry, features and colors within the structure which serve as compelling points of interest as normal human visual navigation.

Execution proceeds to step 466 wherein the visual streams are compared to find disparity (difference) between the location of points on those images and depth is calculated from the disparity (difference). Execution also proceeds in two directions. First execution proceeds to the stereophotogrammetry mapping sub-process steps 464 as described in more detail below. Second, execution proceeds to step 468 wherein system 100 builds a point cloud and known constraints (outside walls) are compared against new constraints (inside walls).

Then again, execution proceeds in two directions. First, system 100 uses the point cloud generated from the stationary objects (and used as reference to the movement of the sensor/camera) to construct a map of obstacles within the structure (e.g., walls, doors) at step 470. Second, execution proceeds to step 472 wherein system 100 calculates position of the operator/user along the X, Y axes.

Execution then proceeds to step 458 wherein system 100 displays the position of the operator/user in the X,Y axes on a generated occupancy grid which corresponds to the floor (Z axis) where the operator is placed.

In FIG. 4D, under the sub-process steps for stereophotogrammetry simultaneous localization and mapping (SLAM) sub-process 460, execution proceeds to the stereophotogrammetry mapping 464 sub-processes as is shown. Next, execution proceeds to step 474 wherein new point cloud generation is compared and updated against a predicted floor plan. The observed floor plan is then overlaid onto the predicted or provided floor plan. (There are three types of floor plans: (1) provided floor plan that is obtained from a third parties such as Zillow, Apartments.com or public safety departments or municipalities, (2) predicted plan which is generated from satellite imagery, pictures taken on scene, mapping tools like streetview and other geographic information system tools, (3) observed plans from operator walking through structure and created from the point cloud as operator moves through the structure.) Execution then proceeds to step 476 wherein the floors are flattened into an occupancy grid. That is, a 3-D point cloud is converted into a 2-D grid.

Under the occupancy grid generation sub-process 480, execution proceeds to steps 482 and 484 wherein taking into account the number of calculated floors, system 100 flattens the point cloud generated into occupancy grids per floor (thus each floor represents its own bin). Execution proceeds to step 486 wherein the firefighter is binned into a corresponding floor, i.e., assigned to a floor within the structure, based on altitude. Execution then proceeds to step 458.

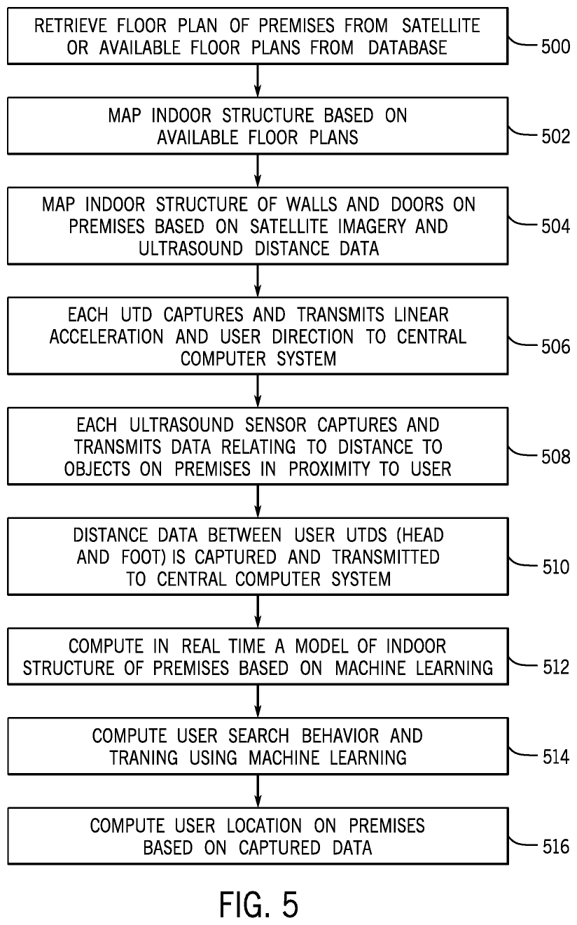

FIG. 5 depicts a flow diagram of the steps or architecture for performing the function of another example tracking system. In brief, the steps generate floor plans, track users (e.g., first responders--firefighters) in 3D on premises (e.g., multi-story building along X, Y, Z axes), and identify users as they enter and exit the premises or incident area. In addition, the platform notifies the incidence commander of detected maydays from falls or abnormalities via health and environmental alerts. The platform is compatible with all existing connected technologies on the fireground and serves as the primary tool for pre-planning as well as consolidating all the information needed for report-outs. The platform steps below represent a high-level process of data collection, analysis and functionality during pre-planning, incidence and post-incidence phases of platform deployment. Note that in this embodiment described below, the platform is stored and operated on a central computer system as needed by and in connection with a mobile device. In another embodiment, the platform and data may be stored and operated on the mobile device and/or cloud itself without a central computer system.

Execution begins at step 500 wherein the floor plan of the premises is retrieved from satellite imagery and/or available floor plans from a database. Specifically, satellite images and floor plans are obtained from sources such as Zillow, Redfin (for example) which will be processed by the machine learning pipeline to ultimately create the likely structure floor layout as described below. Composite premises floor plan images from all sources are stored in a database within the central computer system or in the cloud. Alternatively, data may be stored on the mobile device and cloud without any central computer system.

Execution proceeds to step 502 wherein the existing internal configuration layout is displayed. In some embodiments, the internal configuration may be altered to enhance readability. These floor plans can be pre-planned provided by the Fire Department, Municipality, or other publicly available sources such as Zillow or Redfin.

Execution proceeds to step 504 wherein, in the event available floor plans are not available from third-party sources, the indoor configuration of walls and doors on-premises are generated using a machine learning model based on satellite imagery from sources such as GIS satellite data or from apps such as Google or Microsoft Maps. When no floor plan is publicly available from sources such as Zillow or Redfin for example, the platform utilizes a machine learning (ML) model to predict the layout of the floor plans. This is accomplished through identifying outside constraints (e.g., walls, windows, doors, roof shape, number of stories) collected from satellite imagery (e.g., Google maps, street view or GIS imagery). These constraints are then loaded into a model that is then pulled from the database of the other floor plans to make a prediction of the internal layout.

Execution then proceeds to step 506 wherein linear acceleration, velocity, position and directional data are captured by user mounted UTDs and transmitted to the central computer system to help determine localization (of user). Once a user enters a premises, GPS accuracy and availability may be hindered or blocked so GPS access is terminated in this embodiment. In some detail, the satellite is used for GPS outside the premises and switches to local hardware when the user enters the premise structure. Specifically, the platform (location tracking) switches from GPS to UTDs 104 and mobile device 108 (local hardware) or vehicle computer system 114 once the user enters the premises. GPS is no longer relied upon when inside premises. The platform, described below, thus detects user entry and switches as described in one of two ways. In the first instance, detection occurs when a boundary of the premise structure is actually passed (GPS) and the user enters the premises. In the second instance, detection occurs when the GPS signal “jumps” around indoors, as time to return (signal) is getting significantly elongated as known to those skilled in the art. UTDs and other available data are used to user location tracking as described herein. In the current embodiment, the UTD mounted on a user's helmet, mask, or other embodiment located near the head generates acceleration, velocity and position data (including orientation or direction data) and the pressure sensor will generate Z-axis data. The UTD mounted on the user's foot (e.g., boot), ankle, pocket, or wrist generates step length (X, Y, Z axes) as well as steps up or down between floors (distance) and Z-axis coordinates.

Execution proceeds to step 508 wherein ultrasound sensor data is captured and transmitted to the central computer system. The sensor data relates to the distance from objects in proximity to the user (e.g., firefighter) on premises.

Execution proceeds to step 510 wherein the distance between UTDs (head and foot) is captured and transmitted to the central computer system. The distance data helps to determine the physical status and/or position of the user such as a fallen or collapsed user. The distance data may be captured by direct communication between UTDs or over a network (Internet 110).

Execution then proceeds to step 512 wherein a model of the indoor structure is computed based on a machine learning model. Specifically, floor plan images will be used to create a machine learning tool(s). Training data will be increased with floor plans from satellite images and images through sourcing of publicly available floor plans such as via Zillow, Redfin (for example) which will be processed by the machine learning pipeline to ultimately create a structure's likely floor layout. In addition, neural networks may be used for image segmentation and for distinguishing between buildings, road and other features on satellite imagery. In person (user) data will also be inputted and merged to improve incident command capability to gain insight into the internal building structure to guide user (firefighter) deployment and navigation as described herein and below.

Execution then proceeds to step 514 wherein user search behavior and training are used in the machine learning model to predict user location and direction.

Execution then proceeds to step 516 where user location on premises is determined along with predicted direction based on captured data such as building structures, mapping data, ultrasound data and user behavior. For example, if the sensors indicate the user is moving to the right and then left but based on user behavior and training, the system platform determines that the user may be moving to the right only based on user behavior and training (e.g., firefighters may be trained to move right along a wall during a search). That is, if a majority of sensor data indicates movement to the right, and according to the floor plan, a right-hand search is the preferred method of a user search method, then movement to the right is confidently indicated.

The process steps above may be performed in a different order or with additional steps as known to those skilled in the art.

While not specifically called out by the steps above, the platform for performing the functions of the tracking system described herein enable communication between user UTDs (on multiple users) in order to piggyback onto a network in the event communication between a UTD and mobile device is hindered or blocked. LoRa module meshing is an example protocol employed to enable such communication. The platform also enables access to data from other sources via one or more APIs (for example) such as fireground or fire station computer systems for full accountability of the users (e.g., firefighters) on and off premises and other vehicles rendering service. The platform also enables access data from third party devices such as Apple watch and Fitbit (as examples) via Bluetooth meshing or other protocols of communication.

FIG. 6 depicts a block diagram of an example server of the central computer system shown in FIGS. 1 and 2. In a particular configuration, server 600 typically includes at least one processor 602 and system memory 604 (volatile RAM or non-volatile ROM). The system memory 604 may include computer readable media that is accessible to the processor 602 and may include instructions for execution by processor 602, an operating system 606 and one or more application platforms 608, such as Java and one or more modules/software components/applications 610 or parts thereof. The computer will include one or more communication connections such as network interfaces 612 to enable the computer to communicate with other computers over a network, storage 616 such as a hard drive, video cards 614 and other conventional components known to those skilled in the art. This server 600 typically runs Unix or Microsoft as the operating system and includes TCP/IP protocol stack (to communicate) for communication over the Internet as known to those skilled in the art. A display may be used.

It is to be understood that this disclosure teaches examples of the illustrative embodiments and that many variations of the invention can easily be devised by those skilled in the art after reading this disclosure and that the scope of the present invention is to be determined by the claims below.

What is claimed is:

1. A system configured to (1) determine location of a user and/or objects within a structure and/or (2) create a map of contours of the structure, as the user navigates a space within a structure, the system comprising:
a) an apparatus configured to be mounted on a user and to function in hazardous environments, wherein the apparatus includes first and second sensors configured to generate first and second image streams, respectively, of the structure and/or objects within the structure as the user navigates the space within the structure; and
b) one or more servers configured to communicate with the apparatus via a network, the one or more servers configured to execute a method, the method comprising:
receiving the first and second image streams from the first and second sensors, respectively, of the first and second sensors;
comparing the first and second image streams to determine differences in location of points on the first and second image streams, each difference representative of a location of an obstacle and/or the user with respect to the obstacle; and
creating a point cloud of the location of the obstacles and/or the user within the structure.

2. The system of claim 1 wherein the method further comprises retrieving known location of obstacles of the structure and compare to location of the obstacles in the point cloud to confirm the actual location of the obstacles within the structure.

3. The system of claim 1 wherein the method further comprises calculating a position of the user in X and Y axes in the point cloud.

4. The system of claim 3 wherein the method further comprises assigning a position of the user along a Z axis based on an altitude of the user, the position of the user along the Z axis representative of a floor within the structure.

5. The system of claim 1 wherein the method further comprises displaying the position of the user along the X and Y axes in an occupancy grid corresponding to a floor along the Z axis.

6. The system of claim 1 wherein the method further comprises generating a grid corresponding to one or more floors of the structure.

7. The system of claim 1 wherein the method further comprises creating a grid for display based on the point cloud.

8. The system of claim 1 wherein the method further comprises creating a map of a floor plan of the obstacles based on the point cloud created.

9. The system of claim 8 wherein the method further comprises comparing the map of the floor plan created with a predicted floor plan of obstacles of the structure and updating the created floor plan in the point cloud against the predicted floor plan.

10. The system of claim 1 wherein the apparatus further includes (a) an IMU for determining orientation, direction and/or altitude of the user and/or (b) a sensor for measuring barometric pressure to sense the altitude of the user.

11. The system of claim 8 wherein the map of a floor plan of the obstacles includes walls, doorways and stairwells of a floor.

12. The system of claim 1 wherein the first and second sensors are first and second cameras, respectively.

13. The system of claim 1 wherein the first camera is mounted on personal protective equipment on the user.

14. A system configured to (1) determine a location of a user and/or location of objects within a structure and/or (2) create a map of contours of the structure, as the user moves throughout a structure, the system comprising:
a) an apparatus that is configured to be mounted on a user, the apparatus is configured to provide data monitoring and/or communication of the user to facilitate user deployment and deliver navigation guidance in the hazardous environments, the apparatus includes (1) first and second sensors configured to generate first and second image streams, respectively, of the structure and/or objects on within the structure as the user moves within the structure and (2) one or more user tracking devices (UTDs) for tracking the user as the user moves throughout the structure and configured to receive the first and second images streams; and
b) one or more servers configured to communicate with the one or more user tracking devices via a network, the one or more servers configured to execute a method, the method comprising:
receiving the first and second image streams over the network from the one or more UTDs generated by the first and second sensors, respectively;
comparing the first and second image streams to determine differences in location of points on the first and second image streams, each difference representative of a location of an obstacle and/or the user with respect to the obstacle; and
creating a point cloud of the location of the obstacles and/or the user within the structure.

15. The system of claim 14 wherein the method further comprises calculating a position of the user in X and Y axes in the point cloud.

16. The system of claim 14 wherein the method further comprises creating a map of a floor plan of the obstacles based on the point cloud created.

17. The system of claim 16 wherein the method further comprises displaying the position of the user along the X and Y axes in an occupancy grid corresponding to a floor along the Z axis.

18. The system of claim 14 wherein the method further comprises retrieving known location of obstacles of the structure and compare to location of the obstacles in the point cloud to confirm the actual location of the obstacles within the structure.

19. The system of claim 16 wherein the method further comprises comparing the map of the floor plan created with a predicted floor plan of obstacles of the structure and updating the created floor plan in the point cloud against the predicted floor plan.

20. The system of claim 15 wherein the method further comprises assigning a position of the user along a Z axis based on an altitude of the user, wherein the position of the user along the Z axis representative of a floor within the structure.

21. The system of claim 14 wherein the method further comprises displaying the position of the user in an occupancy grid corresponding to a position on a floor along the Z axis.

22. The system of claim 14 wherein the method further comprises generating a grid corresponding to one or more floors of the structure.

23. The system of claim 14 wherein the method further comprises creating a grid for display based on the point cloud.

24. The system of claim 14 wherein the first and second sensors are first and second cameras, respectively.

25. The system of claim 14 wherein each UTD of the one or more UTDs includes (a) an IMU for determining orientation, direction and/or altitude of the user and/or (b) a sensor for measuring barometric pressure to sense the altitude of the user.

26. A system for real time determining location of users and/or mapping of a structure, as the users move throughout a structure, the system comprising:
(a) a set of nodes that function together as a first network of nodes in which the set of nodes communicate directly with one another and route data between nodes of the set of nodes, wherein each node of the set of nodes comprises a user tracking device (UTD) mounted on a user for tracking the user as the user moves throughout the structure, wherein the UTDs are configured to enable the set of nodes to function as the first network of nodes;
(b) a set of first and second sensors for a set of users, respectively, each set of first and second sensors mounted on each user and in communication with each UTD mounted on the user, each set of first and second sensors mounted on a each user configured to (1) generate first and second image streams respectively of the structure and/or objects within the structure as the user moves throughout the structure and (2) transmit the first and second image streams to the UTD mounted on the user; and
(c) one or more servers configured to communicate with the set of nodes over a second network, the one or more servers configured to execute a method, the method comprising:
receiving first and second image streams over a second network from each UTD generated by each set of first and second sensors, respectively.

27. The system of claim 26 wherein the method further comprises comparing the first and second image streams to determine differences in location of points on the first and second image streams, each difference representative of a location of an obstacle and/or the user within the respect to each obstacle.

28. The system of claim 27 wherein the method further comprises creating a point cloud of the location of the obstacles and/or the user within the structure.

29. The system of claim 28 wherein the method further comprises calculating a position of the user in X and Y axes in the point cloud.

30. The system of claim 29 wherein the method further comprises creating a map of a floor plan of the obstacles based on the point cloud created.

31. The system of claim 28 wherein the method further comprises displaying the position of the user along the X and Y axes in an occupancy grid corresponding to a floor along the Z axis.

32. The system of claim 28 wherein the method further comprises retrieving known location of obstacles of the structure and compare to location of the obstacles in the point cloud to confirm the actual location of the obstacles within the structure.

33. The system of claim 26 wherein each UTD includes (a) an IMU for determining orientation, direction and/or altitude of the user and/or (b) a sensor for measuring barometric pressure to sense the altitude of the user.

34. A system configured to real time simultaneously (1) determine a location of a user and/or location of objects within a structure and/or (2) create a map of contours of the structure, as the user moves throughout a structure, the system comprising:
a) an apparatus that is configured to be mounted on a user, the apparatus is configured to provide data monitoring and/or communication of the user to facilitate user deployment and deliver navigation guidance in the hazardous environments, the apparatus includes (1) first and second sensors configured to generate first and second image streams, respectively, of the structure and/or objects on within the structure as the user moves within the structure and (2) one or more user tracking devices (UTDs) for tracking the user as the user moves throughout the structure and configured to receive the first and second images streams; and
b) one or more servers configured to communicate with the one or more user tracking devices via a network, the one or more servers configured to execute a method, the method comprising:
receiving the first and second image streams over the network from the one or more UTDs generated by the first and second sensors, respectively;
comparing the first and second image streams to determine differences in location of points on the first and second image streams, each difference representative of a location of an obstacle and/or the user with respect to the obstacle;
creating a point cloud of the location of the obstacles and/or the user within the structure; and
creating a map of a floor plan of the obstacles based on the point cloud created.

35. The system of claim 34 wherein the one or more UTDs each includes (a) an IMU for determining orientation, direction and/or altitude of the user and/or (b) a sensor for measuring barometric pressure to sense the altitude of the user.
